(19) United States
(12) Patent Application Publication
(10) Pub. No.: US 2009/0078683 A1
(43) Pub. Date: Mar. 26, 2009

(54) System for and Method of Edge Welding Using Projections

(75) Inventors: Alexander D. Khakhalev, Troy, MI (US); Sanjay M. Shah, Troy, MI (US); Daniel C. Hutchinson, Goodrich, MI (US); Michael D. Regiec, Clarkston, MI (US); Charles J. Bruggemann, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/859,987

(22) Filed: Sep. 24, 2007

(51) Int. Cl. B23K 11/14; B23K 11/34; B23K 11/36

(52) U.S. Cl. 219/78.16

(57) ABSTRACT

A method of edge welding a plurality of workpieces particularly useful for minimizing edge deformation and reducing the electrode size, flange size, welding force and current load necessary to produce a given weld, including the steps of forming at least one distending projection along the edge of a first workpiece, securing the projection against a second workpiece and applying a force and current load to the projection so as to fuse a portion of the projection, and a system for performing the method, including a dedicated projection forming fixture, a resistance welding apparatus preferably having specialized electrodes and a controller communicatively coupled to the fixture and apparatus.

### BACKGROUND OF THE INVENTION

1. Field of the Invention

The present invention relates to the resistance welding of a plurality of workpieces, and more particularly, concerns an improved resistance welding system that utilizes edge projections to reduce the electrode size, flange width, welding force and current load necessary to produce a weld.

2. Discussion of Prior Art

Resistance welding (e.g., conventional mash spot or seam welding) systems, are commonly used for joining workpieces or parts in industries such as automotive manufacture and construction. Typically, after the workpieces have been secured in a desired configuration, at least one, and more commonly two electrodes engage the workpieces as shown in FIGS. 1, 2, and 3. The electrodes function to transmit a sustained force and an electric current through the workpieces until the resistance of the workpieces generates sufficient heat energy to produce a molten weld pool therebetween.

To avoid deforming the workpieces, the duration of applied force and current is configured to produce the weld pool within the confines of the electrode-workpiece interface. As a result, the interface dimensionally limits weld pool formation, such that weld pool requirements contribute to electrode size selection. In prior art FIG. 1, this relationship is illustrated, where first and second electrodes 1, 2 having a first distal width are aligned and applied to a plurality of workpieces, and a weld pool 3 having a width generally congruent to the distal width is produced. Though a smaller electrode may have been structurally sufficient to transmit the necessary force and current, a larger electrode matching the preferred weld size was selected, as is typical in the art.

The use of larger than necessary electrode sizes present various concerns, including increases in repair, replacement, and operational costs such as unnecessary energy consumption, heat generation, and cooling requirements. For example, as shown in FIG. 1, the additional energy load of a conventional cooling tube sub-system 4 is commonly present in prior art systems. Increased electrode sizing presents further concerns relating to workpiece material waste. In this regard, where welding ditches are presented, the ditch 5 (FIG. 2) must present a width sufficient to accommodate the electrode size. As such, where a larger electrode is selected to produce the desired weld size, the ditch 5 must be expanded to accommodate the larger electrode. Similarly, where a welding flange 6 is cooperatively presented by the workpieces (FIG. 3), a flange width greater than the electrode diameter must also be provided.

Of yet further concern, it is appreciated by those of ordinary skill in the art that irrespective of ditch, flange or standard surficial welding, it is difficult to mash weld at the edge of a workpiece, and maintain a clean edge. The necessity to produce a conventional “spot” requires minimum spacing of the weld pool center from the edge. If the electrode is brought to engage the edge, deformation of the edge line and/or an insufficient spot may result. This concern is exacerbated by the selection of larger electrode sizes and the application of associative increased welding loads.

Thus, additional accommodations due to the use of larger electrodes result in realized inefficiencies and costs, including higher repair, replacement, and operational costs. Accordingly, there remains a need in the art for a more cost efficient resistance edge welding system that reduces the necessary electrode size for producing a desired weld.

### BRIEF SUMMARY OF THE INVENTION

Responsive to these and other concerns relating to conventional resistance welding systems, the present invention concerns an improved edge welding system that reduces electrode size by utilizing edge projections. Among other things, the invention is useful for providing a method of joining a plurality of workpieces that is readily implementable in conventional workspace and assembly settings. The invention is also useful for facilitating edge welding with minimal to no deformation of the edge.

In general, the present invention concerns a method of resistance welding first and second workpieces formed of at least one material and presenting first and second workpiece thicknesses, so as to form a joint. The method includes an initial step of determining a projection width based on said at least one material and the workpiece thicknesses. Next, a projection is formed by bending a portion of the first workpiece. The projection presents the projection width, and angularly distends from a remainder of the first workpiece, so as to present a distal edge and a minimum projection angle relative to the remainder. The projection is secured in a fixed position relative to the second workpiece, wherein the edge contacts a planar surface of the second workpiece. A force and electric current are concurrently applied through the projection and to the second workpiece, so that at least a portion of the first and second workpieces, including the projection edge, fuses to form a weld pool. Finally, the weld pool is allowed to cool to form the joint.

It will be understood and appreciated that the present invention provides a number of advantages over prior art resistance welding systems, including, for example, reducing the electrode size, welding force and current load necessary to produce a comparable weld pool size. As a result energy consumption, cooling demands, welding ditch/flange sizes, and incidental costs associated with electrode repair and replacement are also reduced. Moreover, the smaller electrode size results in improved workspace maneuverability.

Other aspects and advantages of the present invention, including preferred projection configurations, and methods of forming the projection and performing projection edge welding will be apparent from the following detailed description of the preferred embodiment(s) and the accompanying drawing figures.

### BRIEF DESCRIPTION OF THE SEVERAL VIEWS OF THE DRAWING

Preferred embodiments of the invention are described in detail below with reference to the attached drawing figures, wherein:

FIG. 1 is a partial elevation and cross-section of a prior art resistance spot welding system, particularly illustrating first and second electrode tips, and a plurality of two workpieces being conventionally spot welded;

FIG. 2 is an elevation of a prior art welding ditch formed by two workpieces, and first and second welding electrodes, particularly illustrating the relationship between the welding ditch width and electrode size;

FIG. 3 is an elevation of a prior art welding flange formed by two workpieces, and first and second welding electrodes, particularly illustrating the relationship between the flange width and electrode size;

FIG. 4 is an elevation of a projection welding system in accordance with a preferred embodiment of the invention, particularly representing a dedicated projection producing fixture, a controller, and a dual-electrode resistance/projection spot welding apparatus;

FIG. 5 is a side elevation of a first workpiece presenting a projection, a second workpiece, and first and second electrodes in pre-projection welding positions, in accordance with a preferred embodiment of the invention;

FIG. 5a is a perspective view of the workpieces shown in FIG. 5, particularly illustrating a plurality of edge projections in the form of bent tabs, and an enlarged inset highlighting a tapered projection, in accordance with a preferred embodiment of the invention;

FIG. 5b is a perspective view of a portion of a workpiece presenting a continuous bent tab edge projection along an outer edge of the workpiece, in accordance with a preferred embodiment of the invention;

FIG. 5c is a perspective view of a portion of a workpiece presenting a plurality of sheared edge projections or flaps, in accordance with a preferred embodiment of the invention;

FIG. 6 is a side elevation of the dedicated fixture for creating projections along an edge of a workpiece, particularly illustrating upper and lower dies, upper and lower die inserts, and a holding pin cooperatively defining a pre-engagement condition;

FIG. 6a is a side elevation of the fixture shown in FIG. 6 in a final engaged condition, wherein the projection is formed by bending the workpiece, in accordance with a preferred embodiment of the invention;

FIG. 6b is a side elevation and enlarged inset of the fixture shown in FIG. 6 in a final engaged condition, wherein the upper form insert presents cutting edges and the projection is further formed by shearing the workpiece, in accordance with a preferred embodiment of the invention;

FIG. 7 is a front elevation of the workpieces and electrodes shown in FIG. 5, particularly showing a lateral projection configuration having tapered walls;

FIG. 7a is a front elevation of the upper workpiece in accordance with a second preferred embodiment of the invention, wherein the projection presents a semi-elliptical lateral shape defining a continuous curvilinear edge;

FIG. 8 is a side elevation of the workpieces and upper electrode shown in FIG. 5 at an intermediate stage of welding, and with a backing block engaging the lower workpiece in lieu of the second electrode;

FIG. 8a is a front elevation of the workpieces, electrode, and backing block shown in FIG. 8;

FIG. 9 is a side elevation of the workpieces, electrode, and backing block shown in FIGS. 8 and 8a, at a final stage of welding;

FIG. 9a is a front elevation of the workpieces and electrodes shown in FIG. 9;

FIG. 10 is a cross-section of upper and lower workpieces cooperatively presenting a welding ditch, and first and second electrodes engaging the workpieces, wherein the first workpiece presents a projection and the electrodes are aligned with the projection in accordance with a preferred embodiment of the invention;

FIG. 11 is a side elevation of upper and lower workpieces cooperatively presenting a welding flange, and first and second electrodes engaging the workpieces, wherein the upper workpiece presents a projection and the electrodes are aligned with the projection in accordance with a preferred embodiment of the invention;

FIG. 12 is a perspective view of a single-sided series welding apparatus having specialized electrodes for performing edge projection welding in accordance with a preferred embodiment of the invention, and a segment of horizontally oriented workpieces cooperatively defining a welding ditch;

FIG. 13 is a perspective view of an exemplary specialized welding electrode adapted for use with the apparatus shown in FIG. 12; and

FIG. 14 is a perspective view of a tapered specialized electrode in accordance with a preferred embodiment of the invention.

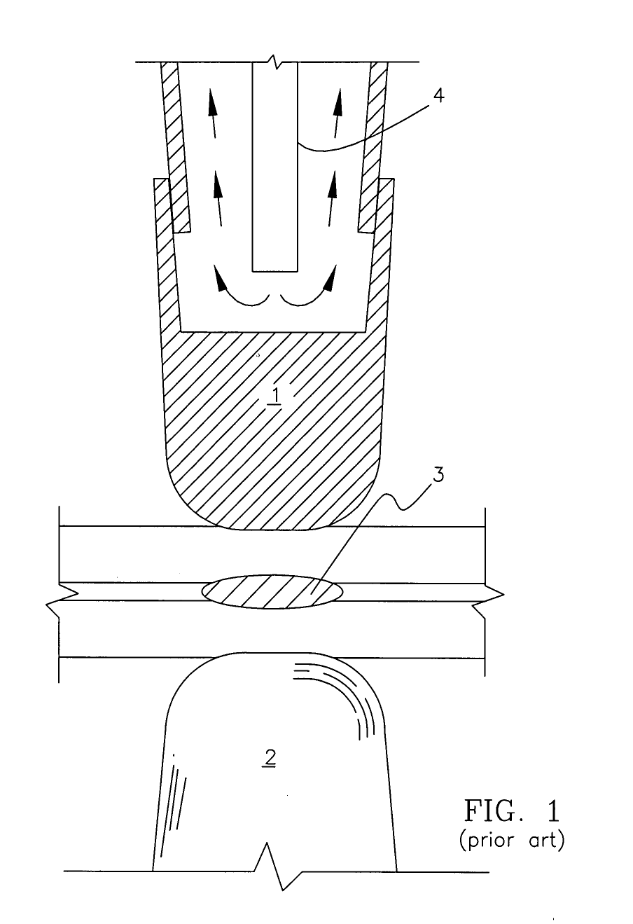

### DETAILED DESCRIPTION OF THE INVENTION

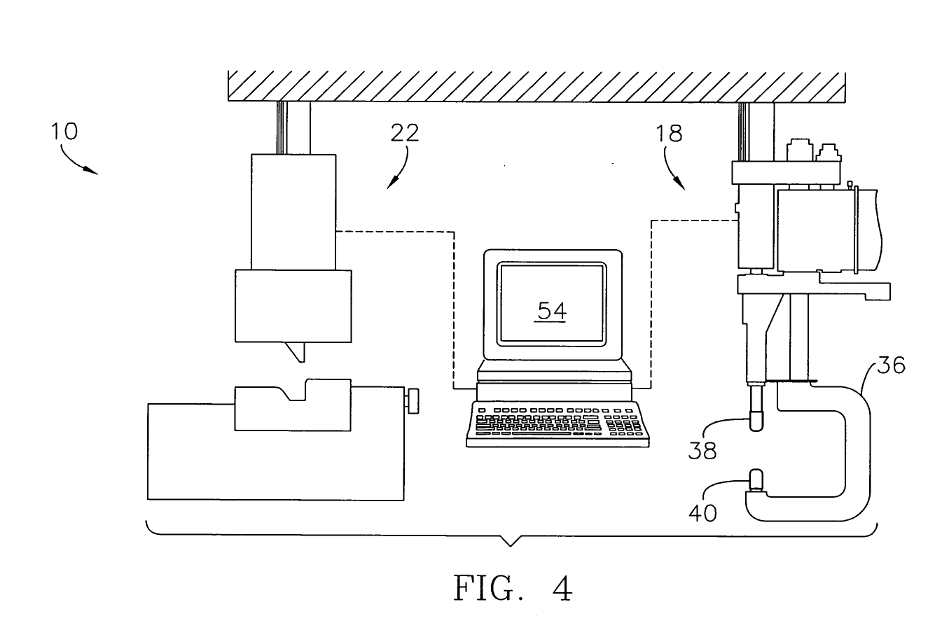

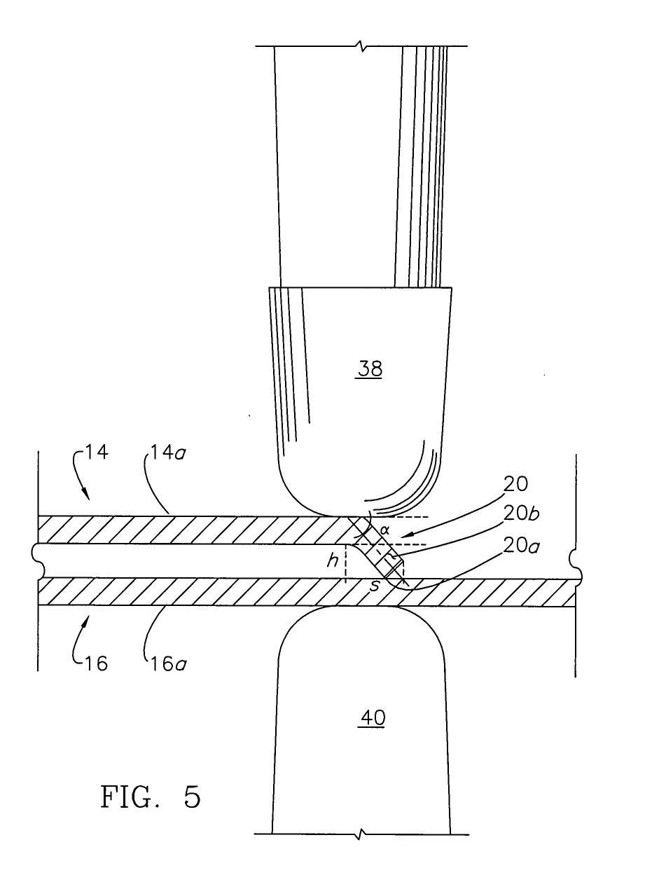

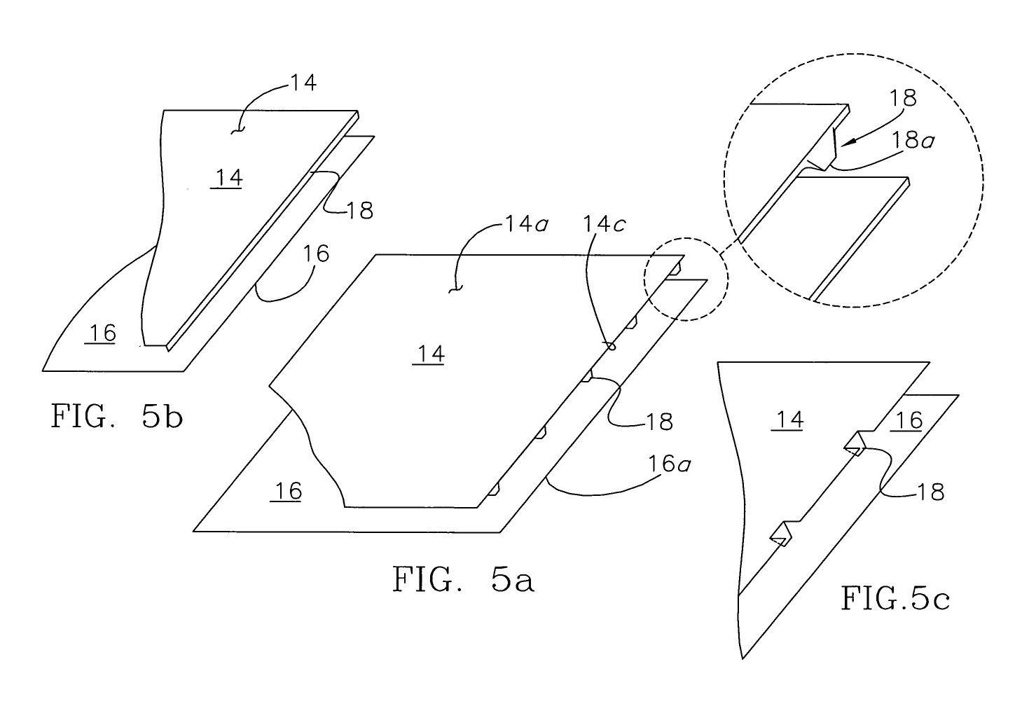

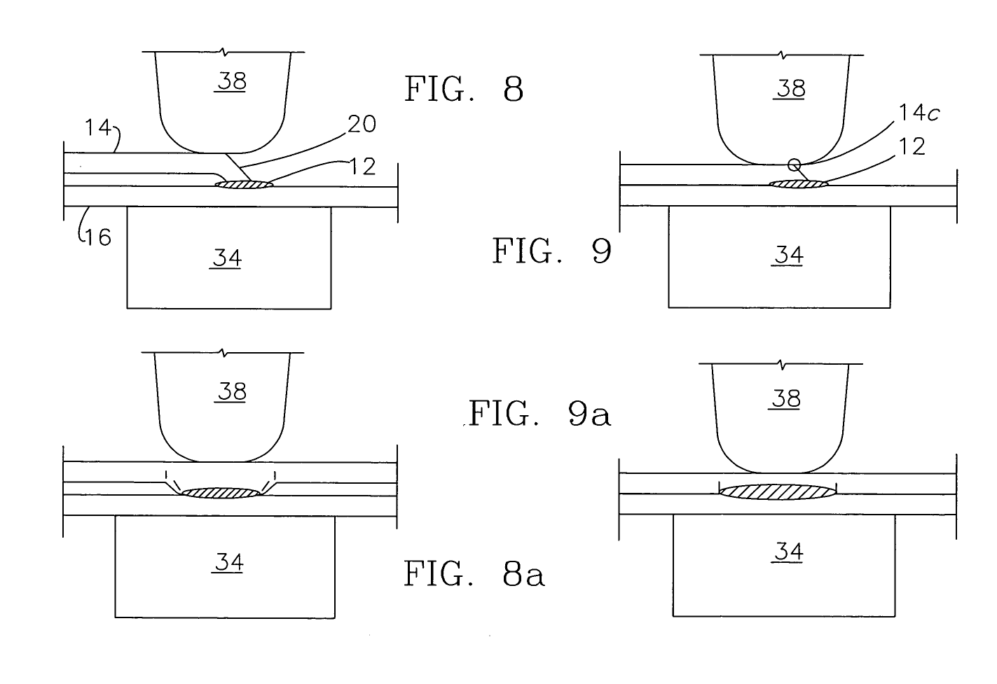

The present invention concerns a resistance welding system 10 (FIG. 4) for welding a plurality (i.e., two or more) of adjacent workpieces, such as automotive sheet metal or engine cradle parts, to produce a spot or seam weld 12 (FIGS. 5 and 8). In the various embodiments described and illustrated herein, a plurality of two workpieces 14,16 of equal thickness is shown; however, the system 10 may be utilized to weld a greater plurality or structural components having variable thickness. The workpieces 14,16 may be formed of a wide range of rigidly solid conductive metals, including steel. In the applications shown in FIGS. 5-5c and 7-11, the sheet metal workpieces 14,16 preferably present opposite major surfaces 14a and 16a, which are engageable by a dual-electrode resistance/projection welding apparatus, such as the apparatus 18 shown in FIG. 4.

A novel aspect of the invention involves the treatment of one of the workpieces 14,16 to produce at least one edge projection 20, prior to welding. In the illustrated embodiment the upper workpiece 14 presents the projections 20 so as to facilitate welding (FIG. 5a); it is certainly within the ambit of the invention, however, for the lower workpiece 16 to bear the projections 20, in which case the functions and configurations described herein would be inverted. The projections 20 are preferably formed by bending a pre-determined portion of the workpiece 14 in a traditional stamping die process. Where seam welding is to be performed, stamping die is the preferred method for producing one long continuous edge projection (FIG. 5b), such as, for example, along the entire length of a roof edge. In this regard, the projections 20 may be formed by an extension of a flange die process.

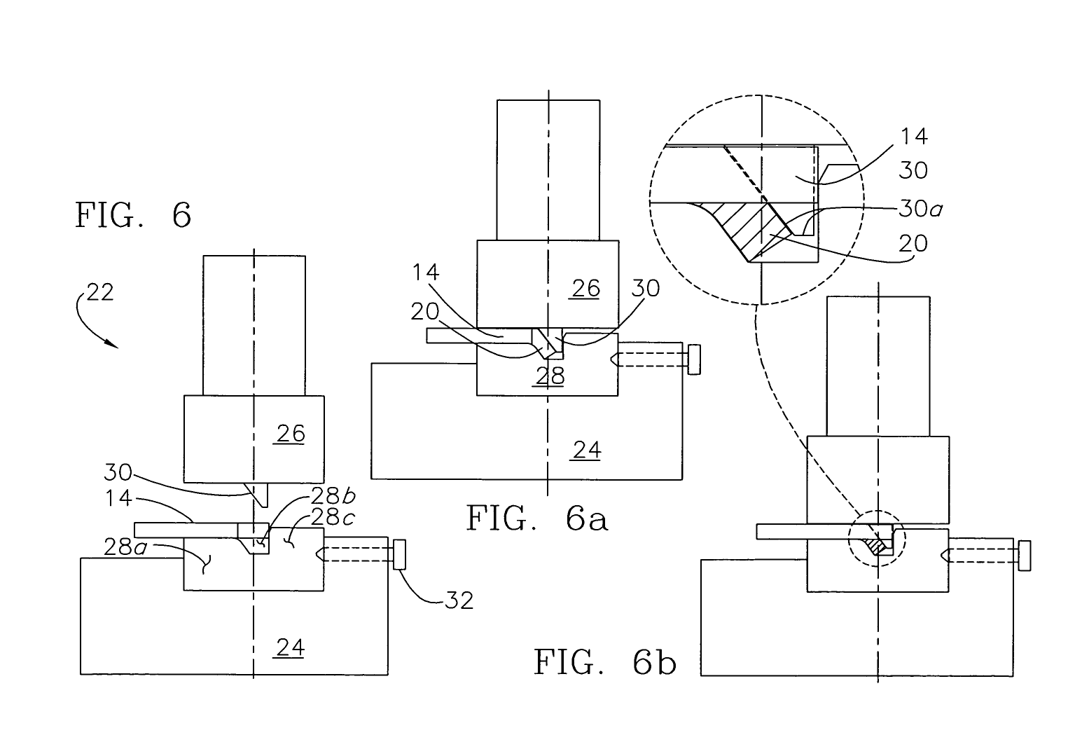

The projections 20 may also be manually constructed by use of a conventional hand tool or saw, or more preferably, by using a special/dedicated fixture 22 (FIGS. 4 and 6-6b) which creates specific shape projections. For applications where intermittent edge projection welding is required, the dedicated fixture 22 is preferred for repetitively producing a plurality of projections 20. A preferred embodiment of the fixture 22 is shown in FIGS. 6-6b, and includes a lower die 24, upper die 26, lower form insert 28, upper form insert 30, and holding pin 32. The lower form insert 28 is configured to cause the workpiece 14 to stop at a particular (pre-defined) distance from the edge. To that end, the lower insert 28 includes a support portion 28a presenting a flat surface for flushly engaging the workpiece 14, a stop portion 28b presenting an elevation greater than the flat surface, so as to abut the workpiece 14, and an indentation 28c (FIG. 6). As shown in FIG. 5, the indentation 28c presents a profile, which allows the creation of an edge projection to a specific depth (or height), h, and a specific angle, a (FIG. 5) for given material properties (e.g., thickness, material tensile and bending strengths, etc.).

Similarly, the upper form insert 30, which engages the workpiece 14, presents a corresponding (e.g., mated) profile. Both the lower and upper form inserts 28,30 are fixedly and more preferably removably connected to the lower and upper dies 24,26, respectively. As shown in FIGS. 6-6b, the fixture 22 is operated by vertically translating the upper form insert 30 along a vertical central axis, once the workpiece 14 has been properly positioned. The upper insert 30 preferably engages the tab along the longitudinal central axis as illustrated, so as to maximize the efficiency of the applied bending force. The geometry of the projection 20 is dictated by the welding process parameters (e.g. current, force, etc.) and material properties, such that the preferred dies 24,26 are removably connectable to a plurality of differing inserts 28,30. Holding pin 32, for example, facilitates interchangeability by providing a manually removable fastener. Finally, the fixture 22 may further include a manual drive mechanism (not shown), such as a lever arm providing mechanical advantage to the operator; but is more preferably hydraulically, pneumatically, or electrically driven.

Thus, each projection 20 is formed by bending a peripheral portion of the first workpiece 14 adjacent the edge defined in part by the major surface 14a. In a first embodiment (FIGS. 5a,b, 6 and 6a) the projections 20 are formed by bending pre-determined portions of the workpiece (e.g., tabs). The final projections 20, in this configuration, extend from an otherwise straight edge 14c, so that the straight edge 14c is maintained after welding (FIGS. 5a and 9). In the alternative embodiment shown in FIGS. 5c and 6b, tabs are not provided along the edge 14c. The projections 20 are formed by shearing and bending the workpiece 14 adjacent the edge 14, so as to produce a plurality of recessed projections 20 or flaps (FIG. 5c). In this configuration, it is appreciated that the upper form insert 30 further presents necessary cutting edges 30a (FIG. 6b).

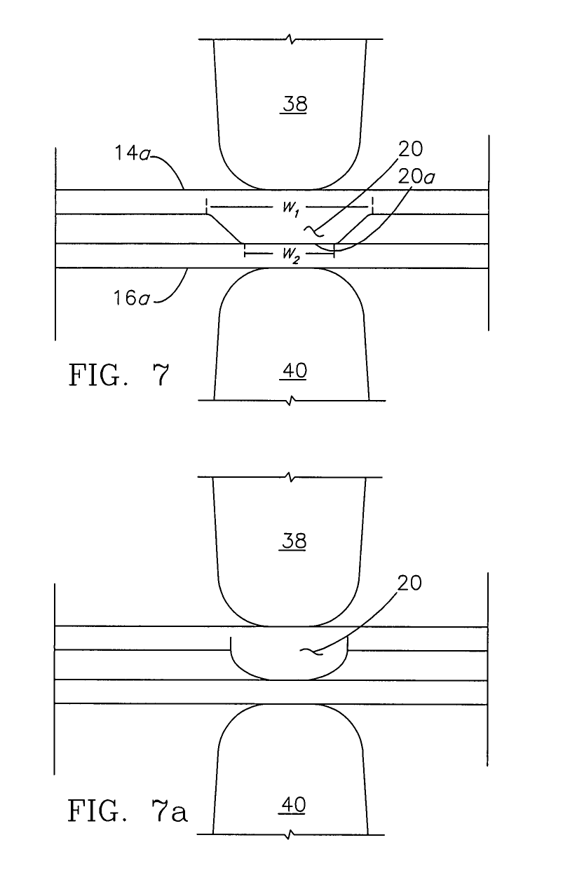

Each projection 20 defines a lateral projection width, w₁, as shown in FIG. 7. The projection 20 angularly distends from the remainder of the workpiece 14, so as to present a distal edge 20a that is preferably parallel to the surface 14a, and a projection span, s (FIG. 5). As shown in FIG. 5, the projecting axis of the projection 20 defines a minimum projection angle, α, with the plane of the major surface 14a, more preferably, an a within the range of 30 to 90, and most preferably within a range of 45 to 60 degrees. As best shown in the inset of FIG. 5a, the preferred projection 20 presents converging outer walls that are tapered so as to narrow towards the distal edge 20a along both the projection thickness and the width. Alternatively, the projection thickness may be constant, as shown in FIGS. 5, 8-11, wherein first and second distal edges are presented with the distal edge of engagement 20a being the lowermost edge.

As shown in FIG. 7, a preferred trapezoidal cross-section results, which maximizes the uppermost width (w₁) to distal edge width (w₂) ratio without causing stability concerns. It is appreciated, for example, that linearly converging the outer projection walls to too narrow of a distal edge 20a may result in a projection 20 that is structurally insufficient to sustain the welding force without crushing or buckling. It is further appreciated that other projection configurations may be utilized, such as, for example, an oval cross-sectional shape (e.g. semi-circular or elliptical) that defines a continuous curvilinear edge (FIG. 7a), as long as a sufficient distal edge portion is presented for engaging the lower workpiece 16. The projection and distal edge widths are preferably sized in relation to the electrode-workpiece interface so that welding loads are evenly applied along the distal edge 20a as the projection fuses.

The distal edge width is preferably pre-determined, and based on the workpiece material to be welded and the application. For example, where the workpiece 14 consists essentially of steel, the workpiece thickness is between 0.6 and 2.0 mm, and the application makes the provision of a proper joint highly critical, then the projection width is preferably within the range 5 to 15 mm and more preferably 10 mm, the distal edge width in a tapered configuration is within the range 3 to 12 mm and more preferably 8 mm, and the projection depth is determined by the formula, 1.25× [the sheet thickness]. As previously mentioned and shown in FIG. 5b, the projection 20 may span an entire workpiece edge (or a large portion thereof) where seam or series welding is desired.

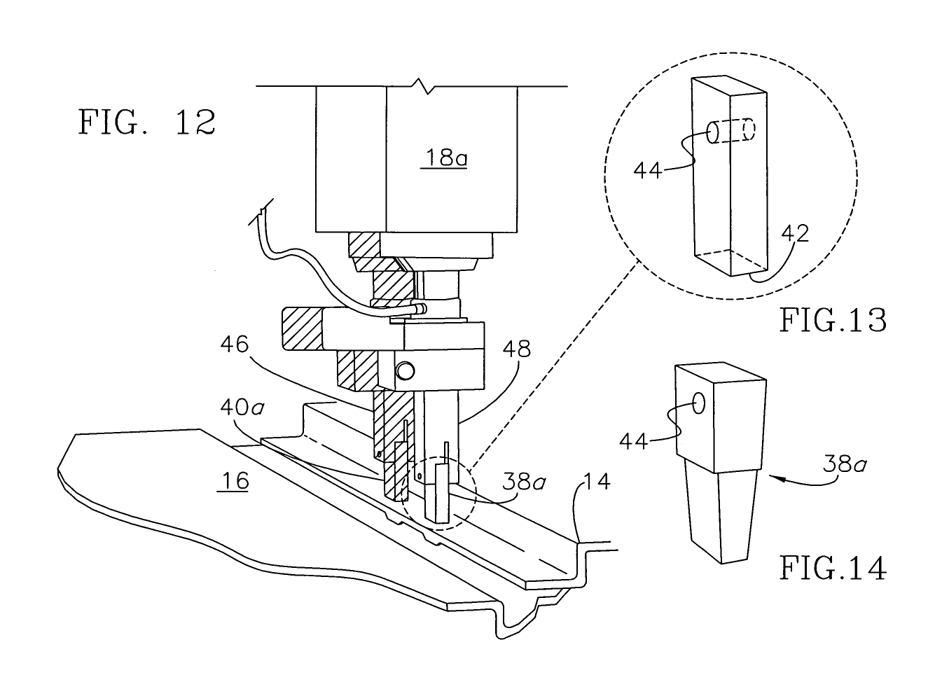

Once the projections 20 have been formed, “edge projection welding” can be performed by the system 10. To that end, a clamping element (not shown) is provided for securing the workpieces 14,16 in a fixed relative position, as is known in the art. Once secured, a resistance welding apparatus 18 is used to engage the workpieces 14,16 so as to produce the weld 12. The system 10 may include a single-sided welding apparatus (excluding a lower electrode) that streamlines the assembly process. In this configuration, a backing block 34 may be positioned and configured to support the lower workpiece 16 either adjacent the weld 12 (FIGS. 8-9a) or at a convenient location away from the joint. In some applications, if the workpieces 14,16 and proposed joint present sufficient stiffness, then a backup is not necessary. For example, a single-sided apparatus 18a having no backing block is shown and later described herein with respect to the specialized apparatus of FIG. 12.

Returning to FIG. 4, an exemplary dual-electrode welding apparatus 18 suitable for use in the present invention is illustrated as having a generally C-shaped structural frame 36, a first electrode or tip 38, a transport mechanism (not shown), and a virtually identical back-up electrode 40. However, it is appreciated that the teachings of the present invention have applicability to other types of conventional welding configurations, including but not limited to pinch guns, scissors guns, and wheel electrode systems. As is typical in the art, the backup electrode 40 in the illustrated embodiment oppositely engages the workpieces 14,16, and completes the electric potential. Given the partial engagement of the upper electrode 38 and projection 20, it is appreciated that more particular care must be given so that the electrodes 38,40 are properly aligned. As such, the system 10 preferably presents precise positioning tolerances symmetrically within 0.1 to 0.2 mm.

The upper electrode 38 is positioned and configured to produce the weld 12 by engaging the workpiece 14 directly opposite the projection 20 (FIG. 5). The electrode 38 contacts the workpiece surface 14a adjacent the projection 20, and is configured to maximize the applied force and minimize the travel path of the current transmitted from the electrode 38, through the projection 20, and to the lower workpiece 16. As shown in FIGS. 5, and 7-11, this is preferably accomplished by engaging approximately half of the electrode tip 38 against the surface 14a so that the longitudinal electrode axis and vector force generally pass through the uppermost projection width, and a sufficient engagement area is provided. It is appreciated that an arc is not formed between the cantilevered portion of the electrode 38 and lower workpiece 16, because the electric potential is dissipated through the projection 20.

In FIG. 12 a single-sided series welding apparatus 18a, which includes first and second specialized electrodes 38a,40a, is shown performing edge projection welding. The electrodes 38a,40a are spaced such that the current load is able to pass from the first electrode 38a, through the desired portions of the workpieces 14,16, including at least one projection 20, and to the second electrode 40a. More preferably, the electrodes 38a,40a are spaced congruently with and engage first and second projections 20, so as to perform concurrent welding.

As best shown in FIGS. 13 and 14, the specialized electrodes 38a,40a are particularly configured to perform edge projection welding. More particularly, the electrodes 38a,40a present rectangular cross-sections that more efficiently overlay, and flat distal engaging surfaces 42 that better engage the projection 20. For example, as shown in FIG. 13, each electrode may present a flat distal engaging surface 42 having an 8 mm width and 20 mm length for ease of positioning the electrode over the projection 20. A depth of 30 mm and a connection hole 44 facilitates connection of the electrodes 38a,40a to first and second electrode holders 46,48 of the apparatus 18a. Alternatively, as shown in FIG. 14, the electrodes 38a,40a may present tapered configurations over at least a portion of the depth. In this configuration, the width of the face 42 may be reduced to 5 mm, in order to further narrow the effective size of the electrode and aesthetically improve the finished weld. Finally, the electrodes 38a,40a preferably present solid members comprising conductive material, such as copper. An interior space for accommodating a cooling tube is not defined, as it is appreciated that the reduced current, force load and cycle time associated with the process enables edge projection welding to be performed with no cooling provision, except exposure to ambient air for natural dissipation.

Whether single-sided or having a mash-welding configuration, the system 10 is preferably configured to fuse the entire below surface projection portion 20b (FIG. 5), so as to primarily obtain the weld pool material from the projection 20 and not the remainder portion of the workpiece 14, as is conventionally the case. That is to say, the molten material from the projection 20, and to a lesser degree the lower workpiece 16 adjacent the distal edge 20a, provides the weld pool material for the weld 12. Thus, the weld pool volume is primarily provided by the projection volume; as such, the depth of the projection (h) should be sized accordingly. Moreover, it is appreciated that a more longitudinal weld pool will result, as opposed to a “spot”, which increases the strength of the weld 12 against generally longitudinal (i.e., edge-wise) forces. It is also appreciated that by fusing the entire below surface projection portion 20b, a minimal (e.g., less than 0.5 mm) gap is presented between the workpieces 14,16 in the final assembly. Finally, the force load and current flow are ceased immediately upon fusion of the below surface projection portion 20b, so that deformation is minimized along the surface 14a.

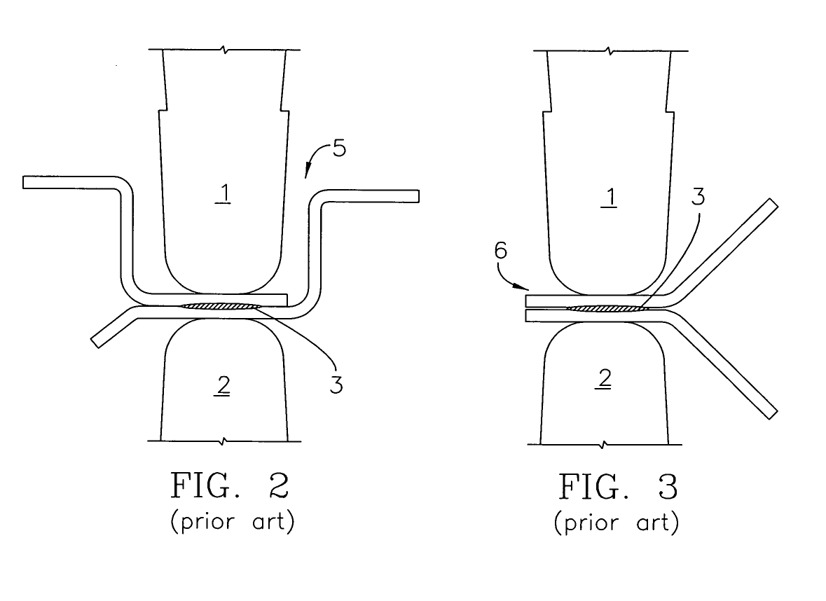

As shown in FIG. 10, the smaller electrode size that results from projection welding is further advantageous during ditch welding, wherein a longitudinal inset or ditch 50 is cooperatively formed by the workpieces 14,16 and the workpiece edge to be welded lies at the invert or bottom thereof. As previously mentioned, the ditch 50 must present a width able to accommodate the distal end portion of the electrode 38. Thus, where the electrode size for achieving a given weld pool is reduced the ditch width may also be reduced (compare FIGS. 2 and 10).

In a laboratory scenario depicted by prior art FIG. 2, for example, a number two welding cap having a maximum in-ditch diameter of approximately 16 mm is utilized in conjunction with a ditch having a 19 mm width. To produce a 5 mm spot weld, a force of 480 lb (or 2136 N) and a current load of 10 kA were applied for 133 ms. In comparison FIG. 10 depicts an edge projection scenario, wherein a more narrow electrode was utilized to produce a congruent weld size. There, the projection 20 presented a distal edge width of 6 mm, the ditch presented a width of 8 mm, and a force of only 100 lb (or 445 N) and current load of 12 kA was applied for only 4 ms (e.g., about a quarter of a conventional welding cycle) to produce a comparable weld.

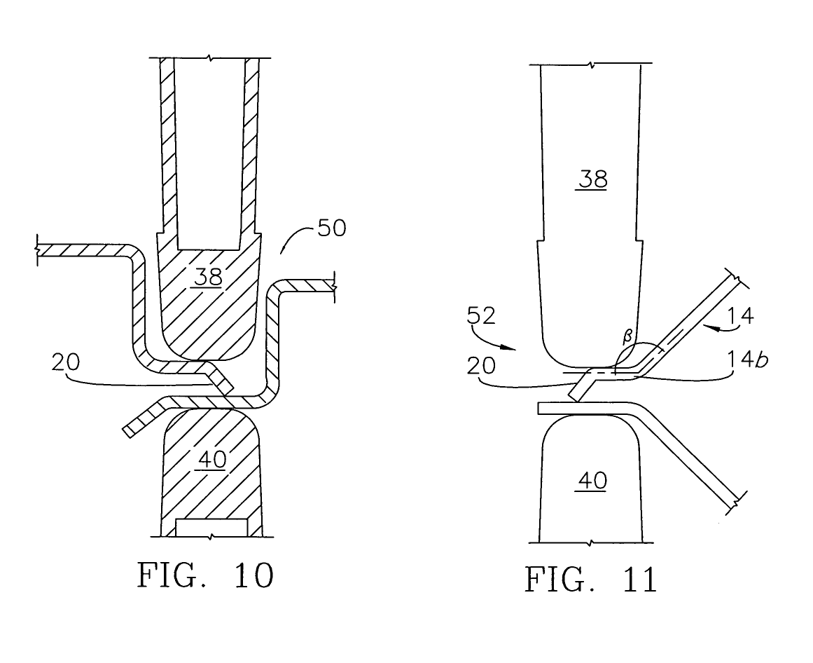

Another configuration wherein further advantages of utilizing a smaller electrode are realized by the present invention is commonly known as flange welding. In FIG. 11, flange projection welding is illustrated, wherein workpieces 14,16 present identical wall angles, β, defined by bend radius, 14b. The workpieces 14,16 cooperatively define a flange 52, and a flange width. Similar to ditch welding, it is appreciated that the smaller electrode size enables a smaller flange width in comparison to prior art FIG. 3.

Finally, the system 10 is preferably robotically operable along multi-axes and programmably controlled, including the initial projection forming steps. For example, as shown in FIG. 4, a controller 54 may be communicatively coupled (i.e., connected by hard-wire or short-range wireless technology) to the dedicated fixture 22, conveying means (not shown), and welding apparatus 18 (or 18a). The controller 54 is operable to perform the projection forming steps at a separate station ahead of the welding apparatus 18, and to that end, may include an relative database that matches workpiece materials and thickness to projection specifications. In this configuration, the fixture 22 is preferably further equipped with sensory means (also not shown) operable to detect proper projection formation and relay correlative data to the controller 54. It is appreciated that this facilitates a mass assembly process, wherein a plurality of projection welds can be performed to join a plurality of sets of workpieces during a welding period.

The preferred forms of the invention described above are to be used as illustration only, and should not be utilized in a limiting sense in interpreting the scope of the present invention. Obvious modifications to the exemplary embodiments and modes of operation, as set forth herein, could be readily made by those skilled in the art without departing from the spirit of the present invention. The inventors hereby state their intent to rely on the Doctrine of Equivalents to assess the scope of the present invention as pertains to any apparatus, system or method not materially departing from the literal scope of the invention set forth in the following claims.

What is claimed is:

1. A method of edge projection welding a first workpiece defining a peripheral edge and presenting a material tensile strength and first workpiece thickness to a second workpiece so as to form a joint, said method comprising the steps of:
a. determining a projection width based on the material tensile strength and projection depth based on the workpiece thickness;
b. forming at least one projection by bending a portion of the first workpiece adjacent the peripheral edge, wherein the projection presents the projection width and angularly distends from a remainder of the first workpiece so as to present a projecting axis, distal edge and a minimum projection angle relative to the remainder;
c. securing the projection in a fixed position relative to the second workpiece, wherein the edge contacts a planar surface of the second workpiece;
d. concurrently applying a force and electric current through the projection and to the second workpiece so that at least a portion of the first and second workpieces, including the edge, fuses to form a weld pool; and
e. allowing the weld pool to cool to form the joint.

2. The method as claimed in claim 1, wherein the first workpiece presents at least one tab adjacent the peripheral edge and presenting the projection width, and step b) includes the steps of forming the projection by bending a tab.

3. The method as claimed in claim 1, wherein step b) further includes the steps of forming the projection by first shearing the portion of the workpiece, so as to present a recessed flap.

4. The method as claimed in claim 1, wherein step b) further includes the steps of producing a projection having a trapezoidal lateral shape, the projection width is presented adjacent the remainder, a distal edge width less than the projection width is defined by the distal edge, and the projection and distal edge widths present a pre-determined ratio.

5. The method as claimed in claim 1, wherein step b) further includes the steps of producing a projection having a semi-circular or elliptical shape and continuous curvilinear edge.

6. The method as claimed in claim 1, wherein step b) further includes the steps of producing the projection using a stamping die process.

7. The method as claimed in claim 1, wherein step b) further includes the steps of mechanically forming the projection by engaging the first workpiece with a specialized fixture including relatively translatable upper and lower dies.

8. The method as claimed in claim 7, wherein step b) further includes the steps of interconnecting upper and lower form inserts in the upper and lower dies, respectively, and engaging the first workpiece with the upper form insert.

9. The method as claimed in claim 1, wherein step b) further includes the steps of forming the projection so that the projecting axis and a plane defined by the remainder of the workpiece cooperatively define a minimum angle between 30 and 90 degrees.

10. The method as claimed in claim 1, wherein step d) further includes the steps of engaging the projection with a first electrode, and engaging the second workpiece opposite the projection with a second electrode, so that the first and second electrodes are aligned, cooperatively produce the force, and complete the electric potential.

11. The method as claimed in claim 1, wherein step a) further includes the steps of determining the projection depth according to the formula, 1.25× [the workpiece thickness].

12. The method as claimed in claim 11, wherein the first workpiece consists essentially of steel, the thickness is between 0.6 and 2.0 mm, and the projection width is between 5 and 15 mm.

13. The method as claimed in claim 1, wherein steps c) and d) further include the steps of securing the workpieces in a relatively fixed position by engaging the second workpiece with a backing block opposite the projection, and applying the force and current by engaging the projection with a single-sided welding apparatus.

14. The method as claimed in claim 1, wherein the projection defines a projection span, and steps b) and c) further include the steps of securing the first and second workpieces in a generally fixed position wherein a welding ditch presenting a ditch width greater than the projection span is cooperatively formed, forming the projection so as to contact the second workpiece within the ditch, and engaging the projection with an electrode portion having a maximum width less than the ditch width and greater than the projection span.

15. The method as claimed in claim 1, wherein the projection defines a projection span, and steps b) and c) further include the steps of securing the first and second workpieces in a generally fixed position wherein a flange presenting a flange width greater than the projection span is cooperatively formed, forming the projection so as to contact the second workpiece within the flange, and engaging the projection with a distal electrode surface having a width less than the flange width and greater than the projection span.

16. A method of edge projection welding a first workpiece defining a peripheral edge and an engaging surface, and presenting material tensile and bending strengths and a first workpiece thickness to a second workpiece so as to form a joint, said method comprising the steps of:
a. determining a projection width based on the material tensile strength and a projection depth based on the workpiece thickness;
b. forming at least one projection by bending a portion of the first workpiece adjacent the peripheral edge by engaging the portion with a fixture including upper and lower form inserts interconnected to relatively translatable upper and lower dies, respectively, wherein the projection presents the projection width and angularly distends from a remainder of the first workpiece so as to present a projecting axis, distal edge and the projecting axis forms a minimum projection angle between 30 and 90 degrees with to the engaging surface;
c. securing the projection in a fixed position relative to the second workpiece, wherein the edge contacts a planar surface of the second workpiece;
d. concurrently applying a force and electric current through the projection and to the second workpiece by engaging the projection with a first electrode and engaging the second workpiece opposite the projection with a second electrode such that the first and second electrodes are aligned and at least a portion of the first and second workpieces, including the edge, fuses to form a weld pool; and
e. allowing the weld pool to cool to form the joint.

17. A projection welding system adapted for welding a plurality of workpieces along a peripheral edge defined by one of said workpieces, said system comprising:
a fixture configured to create at least one projection adjacent the edge by bending a portion of said one of said workpieces adjacent the edge; and
a single-sided resistance welding apparatus configured to apply a force and current to said one of said workpieces adjacent the projection, so as to fuse at least a portion of the projection when the workpieces are secured in a fixed relative condition wherein the projection engages the other of said workpieces,
said fixture including relatively translatable upper and lower dies, a holding pin, and upper and lower form inserts interconnected by the holding pin to the upper and lower dies, respectively, wherein said upper insert is configured to contact and transmit a bending force to the portion.

18. The system as claimed in claim 17, wherein the upper and lower inserts present upper and lower insert profiles respectively, are cooperatively configured to shape the projection according to the profiles, and the upper insert includes first and second cutting edges, so as to shear the portion prior to bending.

19. The system as claimed in claim 17, further comprising:
a controller communicatively coupled to the fixture and apparatus, and configured to actuate the fixture, receive data indicating a successful formation of a projection, and actuate the apparatus only after receiving said data.

20. The system as claimed in claim 17, wherein the projection presents a planar configuration defining a maximum projection width, the apparatus further includes first and section electrodes each presenting a flat distal engaging surface having a rectangular cross-section, and the rectangular cross-section presents an electrode width greater than the maximum projection width.
